(19) United States
(12) Patent Application Publication
(10) Pub. No.: US 2004/0222114 A1
(43) Pub. Date: Nov. 11, 2004

(54) Plumber's caddy for carrying cans of adhesive and primer

(76) Inventor: Steven M. Reed, Malvern, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(21) Appl. No.: 10/839,327

(22) Filed: May 5, 2004

Related U.S. Application Data
(60) Provisional application No. 60/467,879, filed on May 5, 2003.

(51) Int. Cl. B05D 1/28

(52) U.S. Cl. 206/349

(57) ABSTRACT

A combination plumber's caddy and cans of adhesive cement and primer includes a relatively thin, rectangular panel having a first end and a second end. The first end is folded toward and secured to a middle portion of the panel to form a first pocket. A first can of adhesive cement is releasably positioned in the first pocket. The second end is folded toward and secured to a tangent side of the portion of the panel forming the first pocket to form a second pocket. A second can of adhesive primer is releasably positioned in the second pocket. The first and second pockets are open on one end and partially closed on an opposite end to support the cans. A handle extends from at least one of the first or second pockets for carrying the caddy and the cans.

### CROSS-REFERENCE TO RELATED APPLICATIONS

This non-provisional patent application is based on U.S. Provisional Patent Application No. 60/467,879, filed May 5, 2003, the disclosure of which is incorporated herein by reference.

### BACKGROUND OF THE INVENTION

The present invention relates to a PVC cement and primer caddy and, more particularly, to a carrying device that accommodates a can of PVC cement and a can of PVC primer for transportation.

Referring to FIG. 4, plumbers have been carrying first and second cans of PVC cement 1 and PVC primer 2 to bond PVC structures for a number of years. For example, PVC pipes are generally bonded together by initially cleaning a bonding area of the pipes, applying primer from the PVC primer can 2 to the bonding area of the pipes, applying PVC cement to the bonding area of the pipes from the PVC cement can 1 and bringing the bonding area of the two pipes together to bond the pipes. The plumber generally requires both the PVC cement and primer cans 1, 2 on a job site when bonding PVC pipes. In addition, the plumber often bonds PVC pipe at various locations at the job site and at different job sites in the same day. Accordingly, it is important that the PVC cement and primer cans 1, 2 are stored together and are easily transportable from one location to another.

To accommodate transportability and storage of the PVC cement and primer cans 1, 2 together, plumbers often join the PVC cement and primer cans 1, 2 using a length of material 5, such as electric or duct tape 5. The joining of the PVC cement and primer cans 1, 2 with tape 5 permits storage and transport of the cans 1, 2 as a single unit. However, oftentimes either the PVC cement can 1 or PVC primer can 2 runs out of cement or primer prior to the other. When one of the cans 1, 2 runs out of liquid, the empty can is discarded and the can with cement or primer remaining is retained. Accordingly, the cans must be released from the tape 5 when one or the other is discarded and then the remaining useful can must be taped to a new can. When the tape is removed from the cans 1, 2 the labels of the cans 1, 2 are often damaged by being torn from a side of the can. The labels include important instructions and/or safety warnings for the plumber. Accordingly, damage or removal of the labels from the cans 1, 2 is undesirable.

The present invention is a PVC cement and primer caddy that permits storage and transportation of the PVC cement and primer cans 1, 2. The caddy includes a handle that allows easy transportability of the cans 1, 2. In addition, the cans 1, 2 are releasably stored in pockets of the caddy which provide for easy exchange of used cans without damaging the labels on the cans 1, 2 when the cans are inserted or removed from the caddy. Therefore, the caddy of the present invention permits easy transportability of the cans 1, 2 and simple removal and replacement of an empty can with a new can.

### BRIEF SUMMARY OF THE INVENTION

Briefly stated, the present invention comprises a plumber's caddy for carrying cans of adhesive cement and primer. The caddy includes a relatively thin, rectangular panel having a first end and a second end. The first end is folded toward and secured to a middle portion of the panel to form a first pocket. The second end is folded toward and secured to a tangent side of the portion of the panel forming the first pocket to form a second pocket. The first and second pockets are open on one end and partially closed on an opposite end to support a can therein.

In another aspect, the present invention is directed to a combination plumber's caddy and cans of adhesive cement and primer. The combination includes a first can containing an adhesive cement and a second can containing an adhesive primer. The caddy has a first pocket having the first can therein a second pocket having the second can therein. A handle extends from at least one of the first or second pockets for carrying the caddy and the first and second cans.

### BRIEF DESCRIPTION OF THE SEVERAL VIEWS OF THE DRAWINGS

The foregoing summary, as well as the following detailed description of the preferred embodiment of the invention will be better understood when read in conjunction with the appended drawings. For the purposes of illustrating the invention, there is shown in the drawings an embodiment that is presently preferred. It should be understood, however, that the invention is not limited to the precise arrangements and instrumentalities shown. In the drawings:

FIG. 1 is a front perspective view of a caddy with a pair of cans stored therein in accordance with a preferred embodiment of the present invention;

FIG. 2 is a top, rear perspective view of the caddy shown in FIG. 1 without the cans stored therein;

FIG. 3 is a top, front perspective view of the caddy shown in FIG. 2; and

FIG. 4 is a front perspective view of a PVC cement and a PVC primer can secured together using a strip of tape as is conventional in the plumbing art.

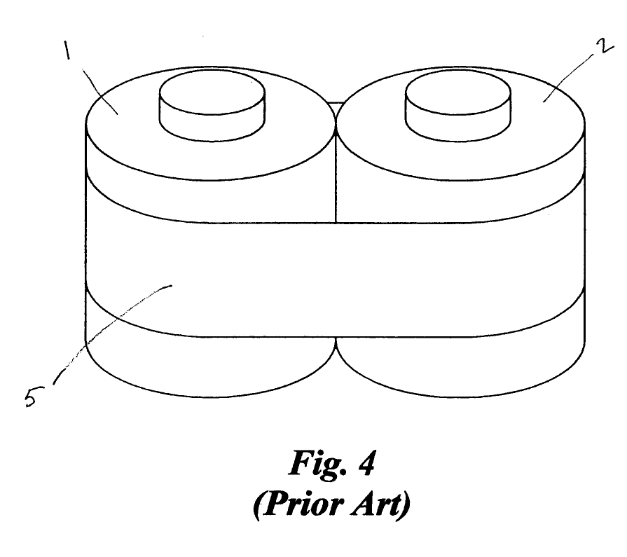

### DETAILED DESCRIPTION OF THE PREFERRED EMBODIMENT

Certain terminology is used in the following description for convenience only and is not limiting. The words “right,” “left,” “lower,” and “upper” designate directions in the drawings to which reference is made. The words, “inwardly” and “outwardly” refer to directions toward and away from, respectively, the geometric center of the plumber's caddy and designated parts thereof. The terminology includes the words above specifically mentioned, derivatives thereof and words of similar import.

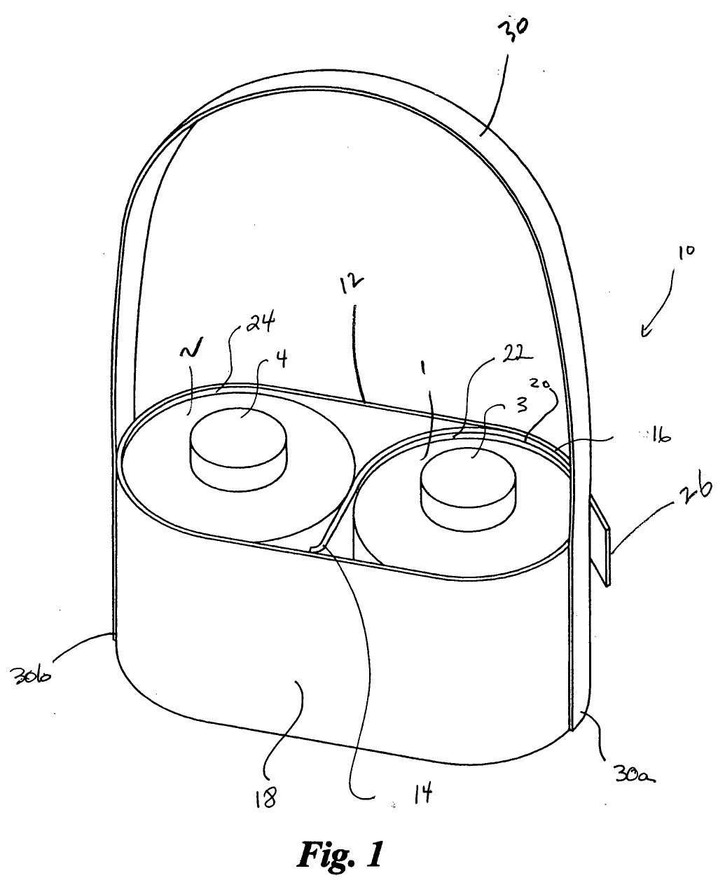

Referring to the drawings in detail, wherein like numerals indicate like elements throughout, there is shown in FIGS. 1-3, a preferred embodiment of a plumber's caddy, generally designated 10, in accordance with the present invention. The caddy 10 is for carrying cans of adhesive cement and primer 1, 2. The first and second cans of adhesive cement and primer 1, 2 are each include a cap 3, 4 threadably secured to a neck (not shown) of the respective can 1, 2. The cans of adhesive cement and primer 1, 2 are well known in the art and, therefore, further description thereof is omitted, secured in the first and second pockets 22, 24. In a preferred embodiment, the cans of adhesive cement and primer 1, 2 are generally cylindrical in shape. However, one of ordinary skill in the art would recognize from this disclosure that the cans could have other forms having nearly any shape and size, such as a parallel piped.

The caddy 10 includes a relatively thin, rectangular panel 12 having a first end 14 and a second end 16. The first end 14 is folded toward and secured to a middle portion 18 of the panel 12 to form a first pocket 22. The second end 16 is folded toward and secured to a tangent side 20 of the portion of the panel 12 forming the first pocket 22 to form a second pocket 24. The first and second pockets 22, 24 are open on one end and partially closed on an opposite end to support one of the first and second cans 1, 2 therein. That is, the first pocket 22 has the first can 1 therein and the second pocket 24 has the second can 2 therein.

In a preferred embodiment, the panel 12 is relatively thin and rectangular in shape and is constructed of a durable, flexible material, such as nylon. It is also preferable that the nylon be woven into a cloth material which is generally stain resistant to withstand the harsh working environment of a plumbing or construction site. One of ordinary skill in the art would recognize from this disclosure that the panel 12 could be constructed of other materials, for example, any material that can be formed to conveniently carry the first and second cans 1,2 that is, the panel 12 may be constructed of nearly any material that is able to withstand the stresses of carrying the first and second cans 1, 2 and that is formable into the general shape of a caddy.

As mentioned above, the first end 14 is folded toward and secured to a middle portion 18 of the panel 12 to form a first pocket 22. In a preferred embodiment, the first end 14 is mechanically secured to the middle portion 18 of the panel 12 by stitching the first end 14 and the panel 12 together. However, it is understood by those of ordinary skill in the art from this disclosure that the first end 14 is not limited to being stitched to the panel 12 and may be adhesively fastened, riveted, bolted, clipped or otherwise secured to the panel 12 without departing from the spirit and scope of the invention.

As mentioned above, the second end 16 of the panel 12 is folded toward and secured to a tangent side 20 of the portion of the panel 12 forming the first pocket 22 to form a second pocket 24. In a preferred embodiment, the second end 16 is secured to the tangent side 20 by a strap 26 that is releasably securable to the panel 12 by a hook and loop material (not shown). However, one of ordinary skill in the art would recognize that the strap 26 is not limited to being releaseably securable to the panel using hook and loop material and may be releaseably securable by buttons, snaps or other releasably securable fasteners. It is also understood that the second end 16 of the panel 10 could be permanently secured to the tangent side 20. In addition, the strap 26 may be replaced by a drawstring (not shown) that could be loosened or tightened.

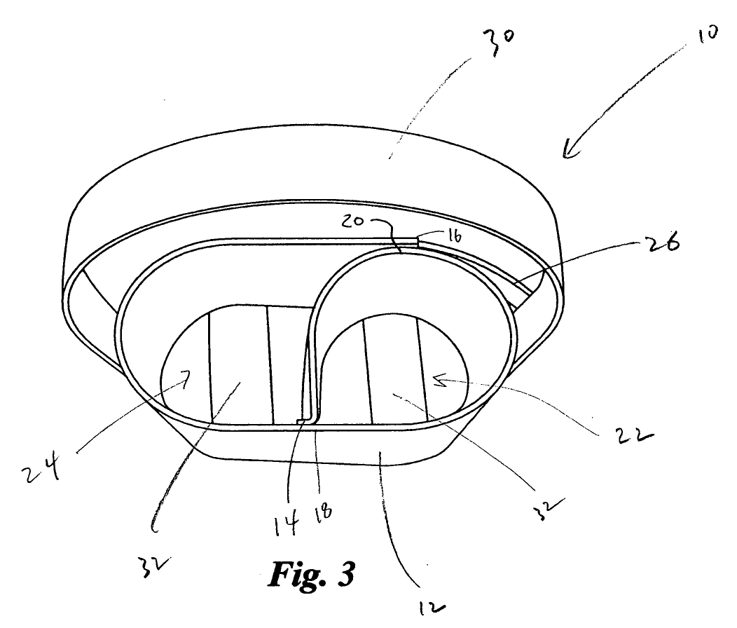

Referring to FIGS. 1 and 3, the caddy 10 includes a handle 30 secured to the panel 12 for carrying the caddy 10. The handle 30 extends from at least one of the first and second pockets 22, 24 and preferably extends between both of the first and second pockets 22, 24. The handle 30 is constructed of a durable cloth material that is flexible, such as nylon, and includes a stiffener (not shown). The stiffener may be constructed of nearly any flexible, resilient material, for example, a polymeric or cardboard material that may be secured within the durable cloth material. In the preferred embodiment, the handle 30 is mechanically secured to the panel 12 by stitching the ends 30a, 30b of the handle 30 to the panel 12. However, one of ordinary skill in the art would recognize that the handle 30 may be adhesively fastened, riveted, bolted, clipped or otherwise secured to the panel 12 without departing from the spirit and scope of the invention.

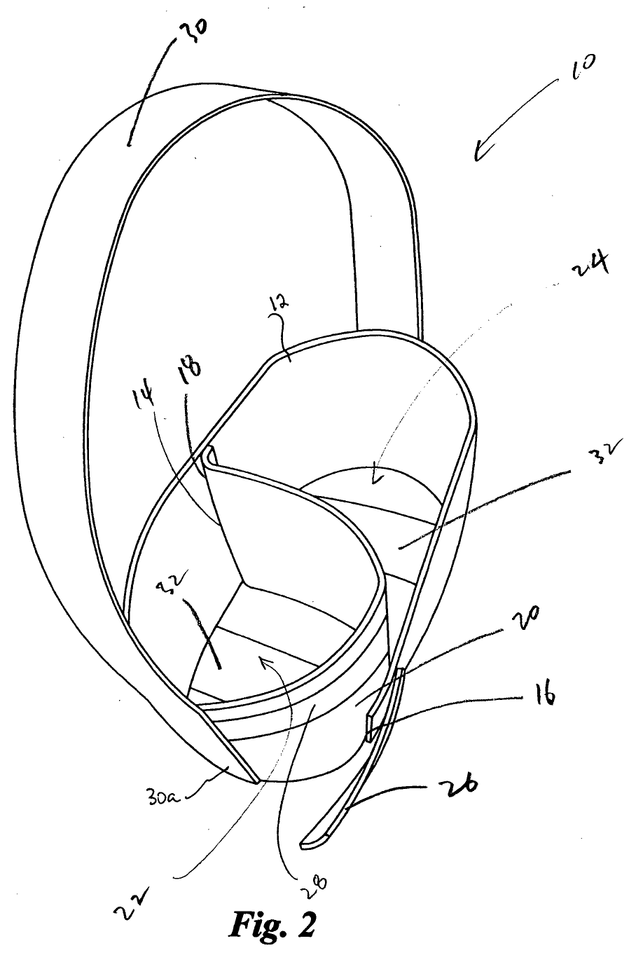

Referring now to FIGS. 2 and 3, the first and second pockets 22, 24 are partially closed by a bottom wall 32. In the preferred embodiment, the bottom wall 32 is formed of a strap extending diametrically across the bottom of the respective pocket 22, 24 an is secured to the panel 12 by stitching. The bottom wall 32 or strap is formed by the same material as the panel 12. It is understood by those of ordinary skill in the art that the bottom wall 32 is not limited to a strap. For instance, the bottom wall 32 could extend across the entire bottom of the respective pocket 22, 24, could be formed by different materials, such as a mesh product and could be omitted entirely if the first and second pockets 22, 24 were sized to frictionally hold the first and second cans 1, 2.

To assemble the caddy 10, the first end 14 of the panel 12 is secured to the middle portion 18 of the panel 12 to form the first pocket 22 via standard stitching. The second end 16 of the panel 12 is folded toward and secured to the tangent side 20 of the portion of the panel 12 forming the first pocket 22 using hook and loop material to form the second pocket 24. The first and second ends 30a, 30b of handle 30 are then secured to the outside of the first and second pockets 22, 24, respectively, using stitching. First and second cans of adhesive cement and primer 1, 2 are then inserted into the first and second pockets 22, 24. The first and second cans 1, 2 are secured within the caddy 10 by pulling the strap 26 to tighten the panel 12 surrounding the cans 1, 2 and then attaching the strap 26 to the tangent side 20 with hook and loop material. The caddy 10 is transported to the work site by carrying the caddy 10 using the handle 30. If one or more of the first and second cans 1, 2 becomes empty it can be removed from the caddy 10 by removing the strap 26 from the side of the first pocket 22 and loosening the panel 12 surrounding the first and second cans 1, 2. A new first or second can 1, 2 can then be inserted as described above.

The plumber's caddy 10 is generally designed to carry cans from one location to another and provides easy removal and replacement of the cans from the plumber's caddy 10. One having ordinary skill in the art will realize that the plumber's caddy 10 may have nearly any shape and be constructed from nearly any material depending upon the application.

Those skilled in the art will appreciate that changes may be made to the embodiment described above without departing from the broad inventive concept thereof. It is understood, however, that this invention is not limited to the particular embodiment disclosed, but is intended to cover modifications within the spirit and scope of the present invention, as described above.

I claim:

1. A plumber's caddy for carrying cans of adhesive cement and primer, the caddy comprising a relatively thin, rectangular panel having a first end and a second end, the first end being folded toward and secured to a middle portion of the panel to form a first pocket, the second end being folded toward and secured to a tangent side of the portion of the panel forming the first pocket to form a second pocket, the first and second pockets being open on one end and partially closed on an opposite end to support a can therein.

2. A caddy as set forth in claim 1, wherein the panel is constructed at least partially of nylon.

3. A caddy as set forth in claim 1, further comprising a handle secured to the panel for carrying the caddy.

4. A caddy as set forth in claim 3, wherein the handle extends between the first and second pockets.

5. A caddy as set forth in claim 1, further comprising a strap extending from the second end, the strap being releasably securable to the portion of the panel forming the first pocket.

6. A caddy as set forth in claim 5, wherein the strap includes a hook and loop material.

7. A caddy as set forth in claim 1, wherein the opposite ends of the first and second pockets are partially closed by a bottom wall.

8. A caddy as set forth in claim 7, wherein the bottom wall includes at least one strap.

9. A combination plumber's caddy and cans of adhesive cement and primer, the combination comprising:
a first can containing an adhesive cement;
a second can containing an adhesive primer;
a caddy having a first pocket having the first can therein and a second pocket having the second can therein; and
a handle extending from at least one of said first and second pockets for carrying the caddy and first and second cans.

10. The combination of claim 9, wherein the caddy comprises a relatively thin, rectangular panel having a first end and a second end wherein the first end is folded toward and secured to a middle portion of the panel to form the first pocket, the second end being folded toward and secured to a tangent side of the portion of the panel forming the first pocket to form the second pocket, the first and second pockets being open on one end and partially closed on an opposite end to support a can therein.

11. The combination of claim 10, wherein the panel is made of nylon.

12. The combination of claim 10, wherein the handle is secured to the panel.

13. The combination of claim 12, wherein the handle extends between the first and second pockets.

14. The combination of claim 10, further comprising a strap extending from the second end, the strap being releasably securable to the portion of the panel forming the first pocket.

15. The combination of claim 14, wherein the strap includes a hook and loop material.

16. The combination of claim 10, where in the opposite ends of the first and second pockets are partially closed by a bottom wall.

17. The combination of claim 16, wherein the bottom wall includes at least one strap.
